(19) United States
(12) Patent Application Publication
(10) Pub. No.: US 2012/0309569 A1
(43) Pub. Date: Dec. 6, 2012

(54) ADJUSTABLE PULLEY FOR A CONTINUOUSLY VARIABLE TRANSMISSION

(75) Inventor: Paulus Adrianus Josephus Maria Faes, Tilburg (NL)

(73) Assignee: ROBERT BOSCH GMBH, Stuttgart (DE)

(21) Appl. No.: 13/518,530

(22) PCT Filed: Dec. 24, 2010
(86) PCT No.: PCT/NL2010/000178

§ 371 Date: Aug. 15, 2012

(30) Foreign Application Priority Data
Dec. 24, 2009 (NL) 1037590

(51) Int. Cl. F16H 9/12

(52) U.S. Cl. 474/46

(57) ABSTRACT

Adjustable pulley (7), in particular for a continuously variable transmission, with a pair of pulley sheaves (9), whereof a first pulley sheave (9) is attached to a pulley shaft (6) of the adjustable pulley (7) and whereof a second pulley sheave (8) is attached to a sleeve (25) of the pulley shaft (6) that is axially displaceable relative to such shaft (6). The adjustable pulley (7) being provided with a conically shaped coil spring (101) that is placed between the second, displaceable pulley sheave (8) and the pulley shaft (6) or a component (26) of the adjustable pulley (7) that is fixed to such shaft (6).

The invention relates to an adjustable pulley, in particular for a continuously variable transmission or CVT, provided with a pair of pulley sheaves or discs whereof one sheave is fixed to a shaft of the pulley and one is axially displaceable relative to the pulley axle, by being provided on a sleeve that is fitted around the pulley shaft. The displaceable sheave is urged towards the fixed sheave by means of a cylindrical coil spring that is held between such displaceable sheave and the pulley shaft or a part of the pulley fixed to the pulley shaft.

Such a pulley is for example known from the European patent publication EP-A-0 777 070 and is used especially in CVTs for passenger motor vehicles. The CVT includes at least two pulleys defining V-shaped grooves between the sheave pairs thereof and a drive belt wrapped around such pulleys, which drive belt is held in the pulley grooves while being clamped between the respective sheave pairs under the influence of a clamping force exerted by at least the said spring. Typically, however, the pulleys are additionally provided with hydraulically actuated piston/cylinder-assembly for urging its displaceable sheave towards it fixed sheave, i.e. for effecting a controllable additional clamping force on the drive belt during operation in addition to the clamping force exerted by the spring. The pulley clamping forces determine both the transmission ratio of, and the torque that can be transmitted by the CVT.

It is known, for example from the European patent publication EP-A-1 427 953, that the pulley sheaves deform elastically under the influence of the clamping force. In particular the sheaves deflect in axial direction away from each other, such that the axial separation there between increases. As a result of such mutual sheave deflection, a radial position (also denoted as a running radius) of the drive belt decreases at least locally, at least such radial position is not constant along the arc-shaped trajectory of the drive belt between the pulley sheaves. The amount of mutual sheave deflection increases along the radial dimension of a respective sheave pair, as well as in relation to an increasing clamping force.

The above-described dynamic deformation behaviour of the CVT is known to be detrimental to the efficiency of the transmission. Still, at the same time, a certain amount of mutual sheave deflection has to be accepted for in a practical CVT design. The present invention departs from this known teaching and aims to further improve on the system performance of the CVT, in particular by optimising the design of the pulleys.

According to the invention this aim is realised by providing the said coil spring of the pulley with an at least effectively conical shape whereof a first end of larger diameter abuts the displaceable sheave and whereof an opposite second end of smaller diameter rests on the pulley shaft or a pulley part fixed to the pulley shaft. As a result, the clamping force exerted by the spring acts on the displaceable sheave at a radial outward position, at least in comparison with the known cylindrical spring, whereby the axial deflection thereof during operation is reduced. More importantly, by the said conical shape of the spring, strengthening or support ribs can be provided between the displaceable sheave and the sleeve radially inside the spring, which support ribs favourably stiffen the displaceable sheave, i.e. favourably reduce the axial deflection thereof during operation. In particular, the support ribs can be designed to completely take up the space provided between the displaceable sheave, its sleeve and the spring in its most compressed state.

Because of the reduction in the axial deflection of the displaceable sheave achieved by the invention, the radial displacement or slip of the drive belt is significantly reduced and the efficiency of the transmission is remarkably improved as a result. An important aspect of the present invention is that this improvement is realised favourably in the same “packaging”, i.e. without the outline of the pulley or pulleys being expanded relative to the prior art pulley design. It is also noted that, like the conventional cylindrical spring, the conical spring too has a linear spring rate.

A further insight underlying the invention is that not only the absolute amount of mutual sheave deflection is a determining factor in the pulley design, but also the relative amounts of axial deflection of its respective sheaves. Namely, if the said amount of mutual sheave deflection is mainly caused by the deformation of only one of the two pulley sheaves, not only does the radial position of the drive belt decrease as described in the known art, but then also its axial position is displaced relative to its theoretical position between two non-deformed, perfectly rigid sheaves. Put differently, due to an asymmetrical distribution of the mutual sheave deflection between the sheaves of the pulley, the middle of the V-shaped groove defined there between shifts in the axial direction towards the most deforming sheave. This axial shift is typically not same for the two pulleys of the CVT, such that a mutual axial alignment of the V-shaped grooves thereof will be affected thereby. Any such axial misalignment is undesirable, because it may reduce the power transmission efficiency of the CVT and/or skews the drive belt when crossing between the pulleys, which may result in an (early) failure thereof.

It is noted that even if two pulleys of essential the same design are applied in the CVT, the said axial shift of the middle of the V-shaped grooves will typically not be equal at all. First of all, a running radius of the drive belt in the V-shaped grooves and hence the amount of axial deflection of the pulley sheaves will typically differ between the two pulleys and secondly the pulleys are normally incorporated in the transmission with their displaceable and fixed sheaves on mutually opposite axial sides.

According to the invention, by stiffening the displaceable sheave, in particular in the above-described manner, the said relative axial deflection of the two pulley sheaves favourably becomes more evenly distributed. Most preferably, the pulley is designed such, i.e. the pulley sheaves are incorporated in a respective pulley such that the axial deflection of the sheaves thereof is essentially the same in the operating condition defined by the highest occurring value for the said drive belt running radius and clamping force in respect of such respective pulley.

The invention will be explained with reference to the attached figures, in which:

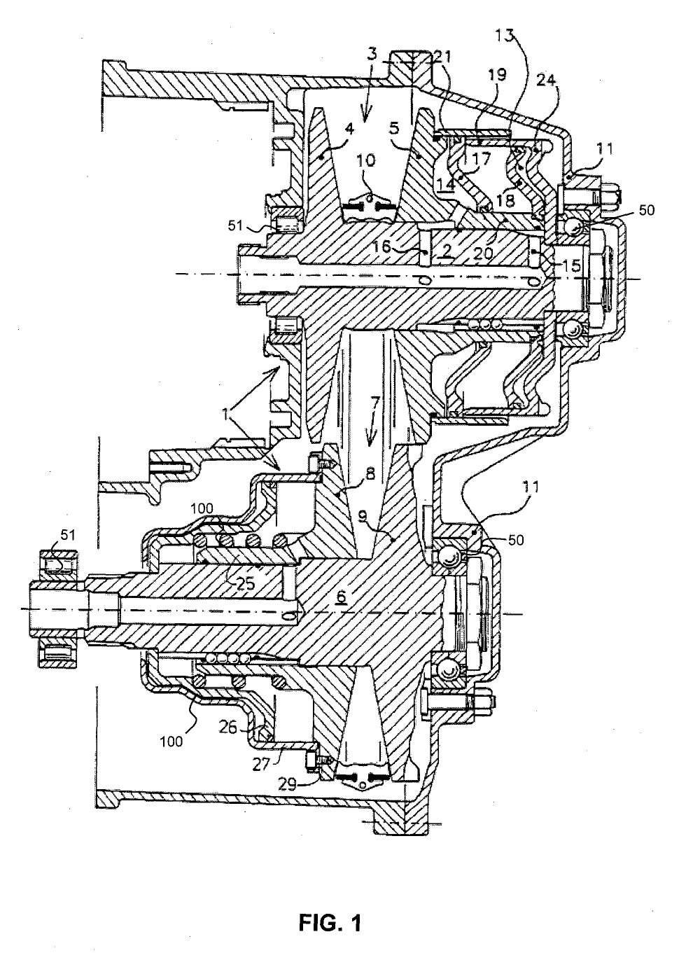

FIG. 1 shows a schematic cross section of a continuously variable transmission with two adjustable pulleys according to the prior art;

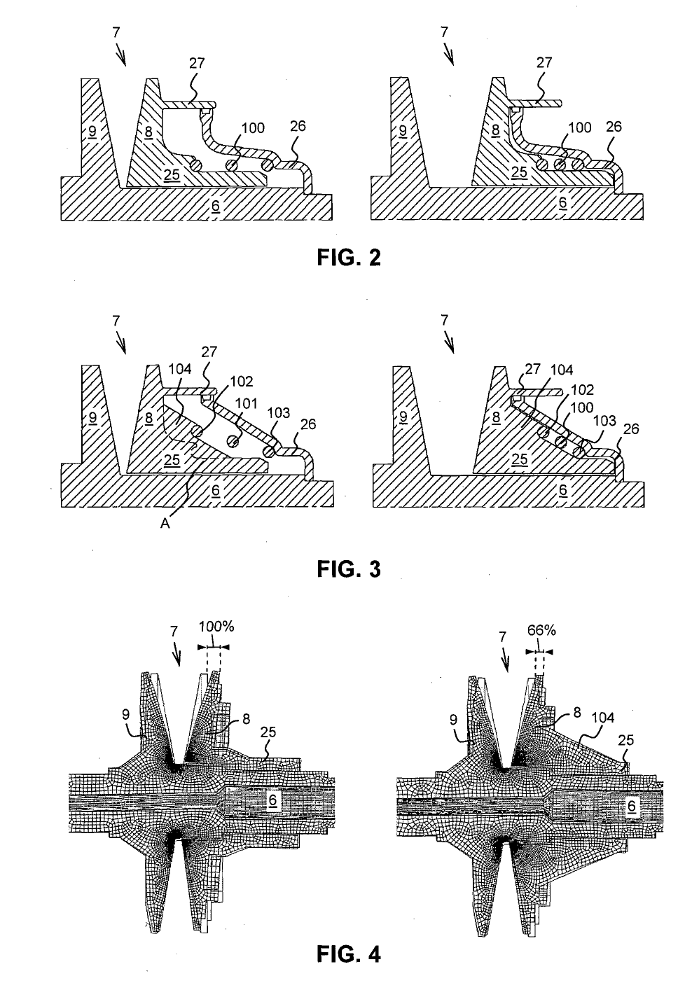

FIG. 2 provides a close-up of a displaceable sheave of the known pulley in its most forward and rearward positions relative to the pulley shaft;

FIG. 3 provides an exemplary embodiment of the displaceable sheave of the pulley according to the invention, likewise illustrated in the most forward and rearward positions relative to the pulley shaft; and

FIG. 4 shows the elastic deformation of the pulley according to the invention in comparison with the known pulley as approximated by means of FEM-analysis thereof.

The continuously variable transmission 1 illustrated diagrammatically and in cross section in FIG. 1 is provided inside a transmission housing 11 with a primary adjustable pulley 3 and with a secondary adjustable pulley 7 according to the prior art. Each one pulley 3, 7 comprises a pair of sheaves 4, 5 and 8, 9, respectively, which sheave pairs 4, 5; 8, 9 are arranged on a primary pulley shaft 2 and secondary pulley shaft 6, respectively. The pulley shafts 2, 6 are mounted in bearings 50, 51 in the transmission housing 11. A first sheave 4, 9 of each pulley 3, 7 is fixed to the respective pulley shaft 2, 6, whereas a second sheave 5, 8 thereof is provided axially displaceable relative to the respective pulley shaft 2, 6 by being placed on a respective sleeve 20, 25 of such respective shaft 2, 6. As a result, the radial position of the drive belt 10 between the pulleys 3, 7 can be changed and the transmission ratio can be set.

The axially displaceable sheaves 5 and 8 are each provided with a hydraulically actuated piston/cylinder-assembly. For the displaceable sheave 8 of the secondary pulley 7, this is a single piston/cylinder assembly 26, 27 and for the displaceable sheave 5 of the primary pulley 3, this is a double piston/cylinder assembly. The double piston/cylinder assembly comprises first and second cylinder chambers 13, 14. The first cylinder chamber 13 is enclosed by the cylinder 19, 24, the piston 18 and the primary pulley shaft 2. The second cylinder chamber 14 is enclosed by the cylinder 21, the piston 17, the displaceable sheave 5 and the sleeve 20 of the primary pulley shaft 2. Fluid can be passed to and from the cylinder chambers 13 and 14 through bores 15 and 16, such that the displaceable sheave 5 and its sleeve 20 are moved axially along the primary pulley shaft 2. The piston/cylinder assembly 26, 27 of the displaceable sheave 8 of the secondary pulley 7 has a similar construction and operation, however, in addition a cylindrical coil spring 100 is provided inside the cylinder 27 thereof for effecting a basic clamping force on the drive belt 10, also in the absence of oil pressure in the piston/cylinder-assemblies. It is noted that in certain transmission designs a spring is applied in a cylinder chamber 13, 14 of the primary pulley 3 as well.

In FIG. 2 the displaceable sheave 8 of the secondary pulley 7 is shown in more detail in the two most extreme axial positions thereof relative to the secondary pulley shaft 6. It can be seen therein that the spring 100 is held between the displaceable sheave 8 on the one hand and, on the other hand, the piston 26 of the piston/cylinder assembly 26, 27 of the secondary pulley 7, which piston 26 is fixed to the secondary pulley shaft 6. Depending on the axial position of the displaceable sheave 8 relative to the secondary pulley shaft 6, the spring 100 is compressed to a greater or lesser extend.

In FIG. 3 an embodiment of the secondary pulley 7 according to the inventions is illustrated. The secondary pulley 7 according to the invention is provided with a coil spring 101 having a conical outer contour, whereof a first end 102 of larger diameter abuts the displaceable sheave 8 and whereof an opposite second end of smaller diameter 103 rests on the piston 26. The clamping force exerted by this conical spring 101 acts on the displaceable sheave 8 at a radial outward position, at least in comparison with the known cylindrical spring 100 in FIG. 2. Hereby, an axial deflection, i.e. a bending outward from the belt 10 of the displaceable sheave 8 under the loading thereof during operation is reduced. More importantly, the conical spring 101 allows for a support rib, ribs or collar 104 to be provided between the displaceable sheave 8 and its sleeve 25 inside the conical spring 101. The dashed line A in the leftmost part of FIG. 3 indicates the conventional contour of the displaceable sheave 8 and its sleeve 25, radially outward wherefrom the support collar 104 is located. This support collar 104 significantly reduces the axial deformation and/or deflection of the displaceable sheave 8. In the embodiment shown, the support collar 104 fills in the space provided between the displaceable sheave 8, its sleeve 25 and the conical spring 101 in its most compressed state.

In FIG. 4 the axial deflection of the displaceable sheave 8 of the secondary pulley 7 according to the known design of FIGS. 1 and 2, calculated for the operating condition with the highest occurring value for both the running radius of the drive belt 10 and the clamping force exerted on the drive belt 10, is illustrated on the left side of FIG. 4. On the right side of FIG. 4 such axial deflection is illustrated for a similar pulley design that is, however, modified in accordance with the present invention by including therein the support collar 104, which is in this case provided over the entire circumference of the pulley 7, i.e. in a continuous cone shaped body. It appears that the absolute amount of such axial deflection of the displaceable sheave 8 of the secondary pulley 7 could be reduced from 0.25 mm to 0.16 mm, i.e. by more than one third. Moreover, by such stiffening of the displaceable sheave 8, its axial deflection can be made essentially equal to the axial deflection of the fixed sheave 9, as is also apparent from FIG. 4.

It is noted that the above example and the number mentioned in relation thereto relate to the minimal modification of a known pulley design by incorporating therein the support collar 104 and as such is merely indicative of the attainable positive result. In case of a complete redesign of the pulley that is fully committed to make optimal use of the invention, a much improved result is in fact attained.

1. Adjustable pulley (7), in particular for a continuously variable transmission (1), with a pair of pulley sheaves (8, 9), whereof a first pulley sheave (9) is fixed to a pulley shaft (6) of the adjustable pulley (7) and whereof a second pulley sheave is (8) placed on a sleeve (25) of the pulley shaft (6), which sleeve (25) is displaceable in an axial or length direction of the pulley shaft (6), characterized in that the adjustable pulley (7) is provided with a conical spring (101) that is provided between the second, displaceable pulley sheave (8) and the pulley shaft (6) or another component (26) of the adjustable pulley (7) fixed to the pulley shaft (6).

2. Adjustable pulley (7) according to claim 1, characterized in that an axial end (102) of larger diameter of the conical spring (101) abuts the second, displaceable sheave (8) and in that an opposite other axial end (103) of smaller diameter of the conical spring (101) abuts the pulley shaft (6) or the another component (26) of the adjustable pulley (7) fixed to the pulley shaft (6).

3. Adjustable pulley (7) according to claim 1, characterized in that the adjustable pulley (7) is provided with a piston/cylinder assembly (26, 27) whereof a piston (26) is fixed to the pulley shaft (6) and in that the conical spring (101) abuts the piston (26).

4. Adjustable pulley (7) according to claim 1, characterized in that in between the sleeve (25) and the second, displaceable pulley sheave (8) a strengthening rib, ribs or collar (104) is provided, located radially inside the conical spring (101).

5. Adjustable pulley (7) according to claim 1, characterized in that the sleeve (25) or the strengthening rib (104) tapers radially outward in the direction of the second, displaceable pulley sheave (8), essentially following the contour of a inner circumference of the spring (101) in its most compressed state.

6. Adjustable pulley (7) according to claim 1, characterized in that during operation thereof, an amount of deformation in an axial direction of the first, fixed pulley sheave (9) is essentially equal to a corresponding amount of deformation of the second, displaceable pulley sheave (8) in the opposite axial direction.

7. Adjustable pulley (7) according to claim 2, characterized in that the adjustable pulley (7) is provided with a piston/cylinder assembly (26, 27) whereof a piston (26) is fixed to the pulley shaft (6) and in that the conical spring (101) abuts the piston (26).

8. Adjustable pulley (7) according to claim 2, characterized in that in between the sleeve (25) and the second, displaceable pulley sheave (8) a strengthening rib, ribs or collar (104) is provided, located radially inside the conical spring (101).

9. Adjustable pulley (7) according to claim 3, characterized in that in between the sleeve (25) and the second, displaceable pulley sheave (8) a strengthening rib, ribs or collar (104) is provided, located radially inside the conical spring (101).

10. Adjustable pulley (7) according to claim 2, characterized in that the sleeve (25) or the strengthening rib (104) tapers radially outward in the direction of the second, displaceable pulley sheave (8), essentially following the contour of a inner circumference of the spring (101) in its most compressed state.

11. Adjustable pulley (7) according to claim 3, characterized in that the sleeve (25) or the strengthening rib (104) tapers radially outward in the direction of the second, displaceable pulley sheave (8), essentially following the contour of a inner circumference of the spring (101) in its most compressed state.

12. Adjustable pulley (7) according to claim 4, characterized in that the sleeve (25) or the strengthening rib (104) tapers radially outward in the direction of the second, displaceable pulley sheave (8), essentially following the contour of a inner circumference of the spring (101) in its most compressed state.
